(19) United States
(12) Patent Application Publication
(10) Pub. No.: US 2015/0227792 A1
(43) Pub. Date: Aug. 13, 2015

(54) Methods and Devices for Object Detection

(71) Applicants: Peter Amon, Munchen (DE); Jan Ernst, Plainsboro, NJ (US); Andreas Hutter, Munchen (DE); Johannes Rehm, Berching - Holnstein (DE); Vivek Kumar Singh, Monmouth Junction, NJ (US)

(72) Inventors: Peter Amon, Munchen (DE); Jan Ernst, Plainsboro, NJ (US); Andreas Hutter, Munchen (DE); Johannes Rehm, Berching - Holnstein (DE); Vivek Kumar Singh, Monmouth Junction, NJ (US)

(21) Appl. No.: 14/177,126

(22) Filed: Feb. 10, 2014

(51) Int. Cl. G06K 9/00; G06K 9/62; G06K 9/46

(52) U.S. Cl. CPC G06K 9/00624; G06K 9/4604; G06K 9/6202

(57) ABSTRACT

Object detection includes providing an image and determining at least one feature point. The at least one feature point defines a location of an image patch used for determining a feature descriptor, and the image patch defines an image area of the image. The feature descriptor is generated based on respective image intensities of a number of respective pairs of pixels with two dimensional coordinates located inside the image patch. An n-th component of the feature descriptor for an n-th pair of pixels is derived. A threshold is set depending on the number. The feature descriptor is generated by an arrangement of the M components. An indication signal is generated for a detected object when the feature descriptor is within a predefined distance to a reference feature descriptor.

### BACKGROUND

The present embodiments relate to methods and devices for object detection.

In recent years, video surveillance applications become more and more popular. Security is enhanced in many areas such as in underground trains or on buses, and automated processes use surveillance technology (e.g., for quality assessment or for controlling processes such as traffic light control).

In order to automate data processing of surveillance images, automatic feature analysis and detection are major challenges. For example, a feature descriptor of a feature analysis and detection system is a representation of features extracted over an image area (e.g., image patch). For the purpose of finding an image patch within a large image (e.g., detection), the representation of the extracted information is to be dissimilar for dissimilar patches and similar for similar patches. The representation may be invariant to certain transformations of the extracted features. The type of invariance that may be desired depends on what the descriptor will be used for. For example, for detecting an object such as pedestrian in natural scenes, invariance to illumination changes may be desirable. Several feature descriptors have been proposed in the literature for the task of object recognition and categorization. However, these descriptors may be computationally expensive to compute.

Recent publications in literature have focused on binary descriptors like ORB and BRISK that are fast to compute. These descriptors are quite robust to transformations caused by illuminations. These descriptors are invariant to every transformation that does not change the sign of the gradients computed between two pixels within the image. This comes at the cost that the amount of extracted information is very limited.

The extracted information is restricted to information about the sign of gradients or in other words the sign of contrasts. For different features, different information may be extracted.

### SUMMARY AND DESCRIPTION

The scope of the present invention is defined solely by the appended claims and is not affected to any degree by the statements within this summary.

There is a need for methods and devices that provide an automatic feature analysis and detection in high quality but with low computational complexity.

The present embodiments may obviate one or more of the drawbacks or limitations in the related art. For example, this need is solved by the methods and systems of the present embodiments.

One or more of the present embodiments relate to a device for object detection. The device includes a first module for providing an image, and a second module for determining at least one feature point. The feature point defines a location of an image patch used for determining a feature descriptor, and the image patch defines an image area of the image. A third module for generating the feature descriptor based on respective image intensities (e.g., luminance) of a number of respective pairs of pixels with two dimensional coordinates located inside the image patch is provided. An n-th component Cn of the feature descriptor for an n-th pair of pixels is derived by

$$Cn ( IP , {a}_{n} , {b}_{n} ) := \{ \begin{matrix}1 , & \vert IP ( {a}_{n} ) - IP ( {b}_{n} ) \vert > tm \\ 0 , & \vert IP ( {a}_{n} ) - IP ( {b}_{n} ) \vert \leq tm\end{matrix}$$

where a threshold tm is set depending on the number. The feature descriptor is generated by an arrangement of the M components. A fourth module for generating an indication signal for a detected object when the feature descriptor is within a predefined distance to a reference feature descriptor is provided.

The device shows the advantage that the execution is simple but robust compared to prior art algorithms. For example, the generation of the respective components allows a fast execution of non-specialized hardware (e.g., a personal computer). In addition, the way the component is generated sets small pixel intensity differences, such as luminance differences, of a pair of pixels to zero and big differences to one. If the biggest pixel intensity differences are between the pixels from the object and pixels from the background, the presented device sets between samples with the same class (e.g., object—object, background—background) to zero and test between samples from different classes to one (e.g., object-background). In addition the device is less sensitive to background clutter and noise.

The image intensity may be defined by luminance, chrominance or any other way to represent image information (e.g., by red, green, blue components of an image pixel). The respective intensity information may be generated by u-bits (e.g., u=16 bits).

The device may be enhanced to generate the feature descriptor by the third module by:

$$FD ( IP ) := {\sum }_{i = 1}^{M} {2}^{i - 1} Ci ( IP , ai , bi )$$

This setting of the feature descriptor results in a binary coded feature descriptor that shows the advantages that the feature descriptor may be coded very tight, and a comparison with reference feature vectors are accomplished with low complexity.

In another embodiment of the device, the third module generates the threshold by:

$$tm := \frac{1}{M} {\sum }_{i = 1}^{M} \vert IP ( {a}_{i} ) - IP ( {b}_{i} ) \vert$$

By this, specific generation of the threshold dedicated properties of the selected pair of pixels of the image patch are considered. By this, a more precise generation of the feature descriptor may be achieved compared to a static threshold.

One or more of the present embodiments relate also to a method for object detection. The method includes providing an image, and determining at least one feature point. The feature point defines a location of an image patch used for determining a feature descriptor, and the image patch defines an image area of the image. The method also includes generating the feature descriptor based on respective image intensities, such as luminance, of a number of respective pairs of pixels with two dimensional coordinates located inside the image patch. An n-th component Cn of the feature descriptor for a n-th pair of pixels is derived by:

$$Cn ( IP , {a}_{n} , {b}_{n} ) := \{ \begin{matrix}1 , & \vert IP ( {a}_{n} ) - IP ( {b}_{n} ) \vert \geq tm \\ 0 , & \vert IP ( {a}_{n} ) - IP ( {b}_{n} ) \vert \leq tm\end{matrix}$$

where a threshold tm is set depending on the number. The feature descriptor is generated by an arrangement of the M components. An indication signal is generated for a detected object if the feature descriptor is within a predefined distance to a reference feature descriptor.

This method shows the same advantages as the corresponding device.

The method may generate the feature descriptor by the third module by:

$$FD ( IP ) := {\sum }_{i = 1}^{M} {2}^{i - 1} Ci ( IP , ai , bi )$$

This setting of the feature descriptor results in a binary coded feature descriptor that shows the advantages that the feature descriptor may be coded very tight, and a comparison with reference feature vectors are to be accomplished with low complexity.

In another embodiment of the method, the threshold is generated by:

$$tm := \frac{1}{M} {\sum }_{i = 1}^{M} \vert IP ( {a}_{i} ) - IP ( {b}_{i} ) \vert$$

By this, specific generation of the threshold dedicated properties of the selected pair of pixels of the image patch are considered. By this, a more precise generation of the feature descriptor may be achieved compared to a static threshold.

### BRIEF DESCRIPTION OF THE DRAWINGS

FIG. 1 shows one embodiment of a device;

FIG. 2 shows a detailed view of one embodiment of a third module of the device; and

FIG. 3 shows an exemplary image patch for generating a feature descriptor.

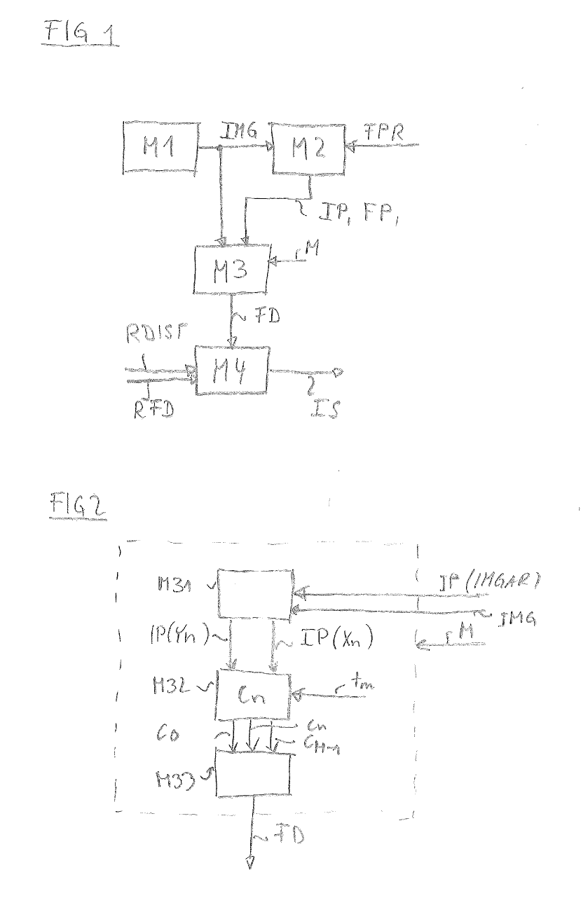

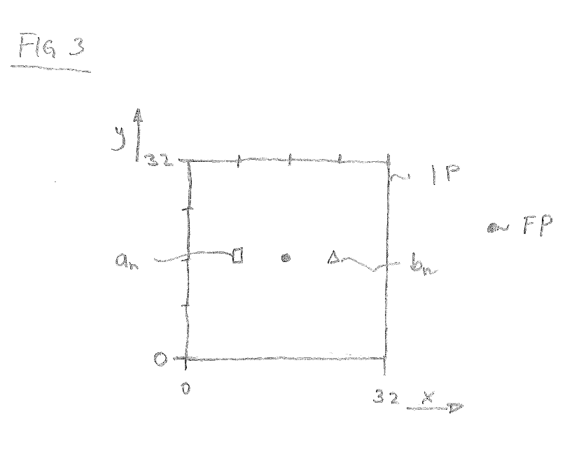

### DETAILED DESCRIPTION

Elements in the figures with the same function are shown by the same element number.

In a first example, an embodiment is described in the area of a manufacturing line. The manufacturing line produces tools made of metal, such as a saw. In order to provide the manufacturing quality of the production line, each manufactured tool is to be inspected visually in order to detect production errors and to be able to discard tools that show, for example, production errors.

In a first act, a first module M1 (e.g., a high resolution camera) generates one image of the tool. The image may consist of 2000×1000 pixels, where each pixel shows a luminance resolution of 16 bit.

In a second act, a second module M2 determines at least one feature point FP. The feature point FP may define a location of an image patch IP that is used for determining a feature descriptor FD. The image patch IP defines an image area IMGAR (e.g., 32×32 pixels) that is located inside the image IMG. The determination of the feature point FP may be performed, for example, by a pre-analysis of edges inside the image and by selecting the feature points at locations inside the image that show a significant edge. The definition of feature points may also be derived from prior art, such as the ORB-method or the BRISK-method.

In a third act performed by a third module M3, the feature descriptor FP is generated. The feature descriptor FP covers a number M of pairs of pixels p(a), p(b). The location of the pixels is inside the image patch IP and is defined by a two dimension vector x, y, i.e. a(x,y), b(x,y). FIG. 3 shows an example of an image patch with 32 pixel locations in the horizontal dimension x and in the vertical dimension y. The feature point of the image patch is located in the central point of the 32×32 sized image patch. Luminance information IP(a), IP(b) at the positions a, b are handed from a first sub-module M31 to a second sub-module M32.

The feature descriptor FP is based on M components, where each component is derived by the luminance information IP(a), IP(b), each located in the image patch IP.

The nth component Cn of the feature descriptor FD is calculated in the second sub-module M32 by:

$$Cn ( IP , {a}_{n} , {b}_{n} ) := \{ \begin{matrix}1 , & \vert IP ( {a}_{n} ) - IP ( {b}_{n} ) \vert \geq tm \\ 0 , & \vert IP ( {a}_{n} ) - IP ( {b}_{n} ) \vert \leq tm\end{matrix} \qquad ( eq . 1 )$$

By equation 1, the nth component Cn is set to 0 if an amount of the luminance difference between the luminance information IP(a) and IP(b) is smaller or equal to a given threshold tm. If the amount is greater than the given threshold tm, the components Cn is set to 1. In this example, the respective component for the feature descriptor FD is binary coded by either 1 or 0.

The threshold tm may be preset for all M components of a feature detector or the threshold tm may be defined by the following equation:

$$tm := \frac{1}{M} {\sum }_{i = 1}^{M} \vert IP ( {a}_{i} ) - IP ( {b}_{i} ) \vert \qquad ( eq . 2 )$$

Equation 2 defines an average of all luminance differences defined by the respective pixel pairs. The feature descriptor FD is then generated by an arrangement of all M components.

In another act, executed by a fourth module M4, an indication signal IS for a detected object is generated if the feature descriptor FD is within a predefined distance FDIST to one or several reference feature descriptors RFD. The reference feature descriptors are part of a code book generated offline with predefined images to result reference feature descriptors that show an existence of a given object. The distance between the feature descriptor and the reference feature descriptor may be calculated by a component-wise analysis of different values of the components. For example, each feature descriptor includes 512 components. If less than 40 components are different (e.g., at least 473 components are the same), an object is detected. Otherwise, as the predefined distance RDIST is higher than preset, there are more differences between the reference feature descriptor and the feature descriptor. This results in the conclusion that the feature descriptor and the reference feature descriptor are not identical enough, and in this case, no indication signal IS is generated.

The indication signal IS may be used in the production line to signal to staff or to a switch that discards the tool that was identified by a feature descriptor not being identified as a error-free tool in comparison to a reference feature descriptor. By this, erroneous tools may be extracted from the production line, and the quality of produced tools may be increased.

The feature descriptor may be generated by the aid of a third sub-module M33 that receives the components CO, Cn, Cm−1 by:

$$FD ( IP ) := {\sum }_{i = 1}^{M} {2}^{i - 1} Ci ( IP , ai , bi ) \qquad ( eq . 3 )$$

By using a binary representation for each component of the feature descriptor, both a very compact representation of the feature detector may be coded, and the comparison between the feature detector and the reference feature descriptors may be executed on general purpose computers with low computational power.

The proposed feature descriptor is invariant to linear transformations such as c×IP (x, y)+d, (c>0). A linear transformation affects the threshold tm, which changes to:

$$\begin{matrix}{t}_{m , l} = \frac{1}{M} {\sum }_{i = 1}^{M} \vert ( c \cdot IP ( ai ) + d ) - ( c \cdot IP ( bi ) + d ) \vert \\ = c \cdot \frac{1}{M} {\sum }_{i = 1}^{M} \vert IP ( {a}_{i} ) - IP ( {b}_{i} ) \vert \\ = c \cdot {t}_{m}\end{matrix}$$

The advantage, for example, in combination with the binary representation of the components shows that the linear transformation does not affect the binary tests.

A proof is shown by the following equation:

$$\begin{matrix}C ( c \cdot IP + d ; a , b ) = \{ \begin{matrix}1 , \vert ( c \cdot IP ( a ) + d ) - ( c \cdot IP ( b ) + d ) \vert > {t}_{m , l} \\ 0 , \vert ( c \cdot IP ( a ) + d ) - ( c \cdot IP ( b ) + d ) \vert \leq {t}_{m , l}\end{matrix} \\ = \{ \begin{matrix}1 , c \cdot \vert IP ( a ) - IP ( b ) \vert > c \cdot {t}_{m} \\ 0 , c \cdot \vert IP ( a ) - IP ( b ) \vert \leq c \cdot {t}_{m}\end{matrix} \\ = \{ \begin{matrix}1 , \vert IP ( a ) - IP ( b ) \vert > {t}_{m} \\ 0 , \vert IP ( a ) - IP ( b ) \vert \leq {t}_{m}\end{matrix} \\ = C ( IP ; a , b )\end{matrix}$$

The present embodiments were explained with an example from a production line. The present embodiments, however, are not limited to this particular example but may be used for a variety of other applications such as people tracking, car tracking or other object tracking in visual images. The definition of the image patch may not be a square image area. The definition of the image patch may be of any shape such as circular or other shapes. Determination of the feature points may be selected such that each component uses a different pair of pixels compared to other components of the same feature descriptor. For example, the BRISK-algorithm defines a sampling pattern, where the pixels are arranged to reflect standard deviation of Gaussian smoothing.

The modules M1 to M4 may be implemented in software, hardware (e.g., one or more processors) or a combination of software and hardware. The modules M1 to M4 may be coded, at least partially, in machine readable code, stored in a memory (e.g., a non-transitory computer-readable storage medium) that is connected to a central processing unit. The central processing unit in addition is connected to input-output interfaces for retrieving the image and for outputting the indicator signal.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A device for object detection, the device comprising:
an imaging device operable to provide an image;
a processor configured to:
determine at least one feature point, wherein the at least one feature point defines a location of an image patch IP used for determining a feature descriptor FD, and the image patch defines an image area of the image;
generate the feature descriptor based on respective image intensities of a number M of respective pairs of pixels (p(x), p(y)) with two dimensional coordinates located inside the image patch, wherein an n-th component Cn of the feature descriptor for an n-th pair of pixels (p(aₙ), p(bₙ)) is derived by:
$$Cn ( IP , {a}_{n} , {b}_{n} ) := \{ \begin{matrix}1 , & \vert IP ( {a}_{n} ) - IP ( {b}_{n } ) \vert > tm \\ 0 , & \vert IP ( {a}_{n} ) - IP ( {b}_{n } ) \vert \leq tm\end{matrix}$$
wherein a threshold TM is set depending on the number, and wherein the feature descriptor is generated by an arrangement of the components; and
generate an indication signal for a detected object when the feature descriptor is within a predefined distance to a reference feature descriptor.

2. The device of claim 1, wherein the processor is configured for generating the feature descriptor by
FD(IP):=Σᵢ₌₁^{M}2ⁱ⁻¹Ci(IP, ai, bi).

3. The device of claim 1, wherein the processor is configured to generate the threshold by:
$$tm := \frac{1}{M} {\sum }_{i = 1}^{M} \vert IP ( {a}_{i} ) - IP ( {b}_{i} ) \vert .$$

4. The device of claim 2, wherein the processor is configured to generate the threshold by:
$$tm := \frac{1}{M} {\sum }_{i = 1}^{M} \vert IP ( {a}_{i} ) - IP ( {b}_{i} ) \vert .$$

5. A method for object detection, the method comprising:
providing an image;
determining, with a processor, at least one feature point, wherein the at least one feature point defines a location of an image patch used for determining a feature descriptor, and the image patch defines an image area of the image;
generating the feature descriptor based on respective image intensities of a number of respective pairs of pixels with two dimensional coordinates located inside the image patch, wherein an n-th component of the feature descriptor for an n-th pair of pixels is derived by:
$$Cn ( IP , {a}_{n} , {b}_{n} ) := \{ \begin{matrix}1 , & \vert IP ( {a}_{n} ) - IP ( {b}_{n } ) \vert > tm \\ 0 , & \vert IP ( {a}_{n} ) - IP ( {b}_{n } ) \vert \leq tm\end{matrix}$$
wherein a threshold is set depending on the number (M);
generating the feature descriptor by an arrangement of the M components; and
generating an indication signal for a detected object when the feature descriptor is within a predefined distance to a reference feature descriptor.

6. The method of claim 5, further comprising generating the feature descriptor by:
FD(IP):=Σᵢ₌₁^{M}Ci(IP, ai, bi).

7. The method of claim 5, further comprising generating the threshold by:
$$tm := \frac{1}{M} {\sum }_{i = 1}^{M} \vert IP ( {a}_{i} ) - IP ( {b}_{i} ) \vert .$$

8. The method of claim 6, further comprising generating the threshold by
$$tm := \frac{1}{M} {\sum }_{i = 1}^{M} \vert IP ( {a}_{i} ) - IP ( {b}_{i} ) \vert .$$
